(19) United States
(12) Patent Application Publication
(10) Pub. No.: US 2015/0030453 A1
(43) Pub. Date: Jan. 29, 2015

(54) TOROIDAL AND THRUST BEARING ASSEMBLY

(71) Applicant: AKTIEBOLAGET SKF, GÖTEBORG (SE)

(72) Inventor: Christian Zang, Nordheim (DE)

(21) Appl. No.: 14/380,257

(22) PCT Filed: Feb. 18, 2013
(86) PCT No.: PCT/SE2013/000024

§ 371 Date: Aug. 21, 2014

(30) Foreign Application Priority Data
Feb. 21, 2012 (SE) 1200103.8

(51) Int. Cl. F03D 11/00; F16C 19/38; F16C 43/06; F16C 23/08

(52) U.S. Cl. CPC F03D 11/0008; F16C 23/08; F16C 19/381; F16C 43/06
USPC 416/174; 384/455

(57) ABSTRACT

The present invention relates to a bearing assembly for supporting a shaft having a toroidal roller bearing arrangement. The bearing assembly includes a first set of rolling elements formed of toroidal roller elements arranged in a first row and interposed between an inner ring providing a first inner raceway and an first outer ring providing a first outer raceway, and a thrust bearing arrangement having a second set of rolling elements arranged in a second row. The rolling elements are in contact with and arranged to cooperate with a second inner raceway and a second outer raceway for supporting axial loads and for restricting axial movement of the shaft in relation to the first outer ring. The present invention also relates to a method for manufacturing a bearing assembly for supporting a shaft.

### FIELD OF THE INVENTION

The present invention relates to the field of rolling-element bearing arrangements, and more specifically to a bearing assembly for supporting and axially locating a rotating shaft, such as a wind turbine rotor shaft, which assembly comprises a toroidal roller bearing arrangement which allows for self-aligning capability in combination with at least partial unconstrained axial displacement, and a thrust bearing arrangement.

The present invention also relates to a method for manufacturing a bearing assembly for supporting a shaft, which assembly comprises a toroidal bearing arrangement.

### BACKGROUND ART

During high torque transfer and high load applications comprising a rotating shaft in space-limited housings, such as a rotor shaft of a wind turbine, the rotating shaft is commonly supported by a spherical roller bearing which has a spherical geometry allowing for self-alignment of the shaft during operation. By self-alignment, the angular alignment of the rotational axis of the rotating shaft may change in relation to the bearing such that angular movements of the shaft in relation to a housing is permitted. During operation, in order to provide suitable operation and to reduce wear and damage to connected and/or surrounding equipment, such as gear boxes, etc, the axial movement of the rotating shaft must be restricted by the spherical roller bearing. Any excessive axial play may considerably reduce the life time of the application arrangement.

In order to provide suitable and durable axial locating function of the spherical roller bearing, the size and radial dimension of the spherical geometry of the spherical roller bearing is increased which increases the contact angles between the rollers and raceway in relation to the axis of the rotating shaft. Furthermore, the required spherical geometry of the spherical bearing is further increased by the required radial dimension of the rotating shaft which must be design to withstand the required torque level of the application.

Hence, known solutions involving a self-aligning and axially locating spherical roller bearing suffer from overdesigning in relation to e.g. radial load bearing capacity. Also, in order to provide sufficient axial load bearing function, known solutions entail non-compact designs with large bearings which occupy valuable space. Furthermore, designing with large bearings sizes leads to high material cost and high bearing mass which limits the operational efficiency by e.g. increasing the rotational inertia of the arrangement.

### SUMMARY OF THE INVENTION

In view of the above-mentioned and other drawbacks of the prior art, a general object of the present invention is to provide an improved bearing assembly and method for manufacturing such bearing assembly.

These and other objects are met by the subject matters provided in the independent claims. Preferred embodiments of the invention are presented in the dependent claims.

According to a first aspect thereof, the present invention relates to a bearing assembly for supporting a shaft, comprising a toroidal roller bearing arrangement comprising a first set of rolling elements formed of toroidal roller elements, which roller elements are arranged in a first row and interposed between an inner ring comprising a first inner raceway and a first outer ring comprising a first outer raceway, wherein the first inner and outer raceways are in contact with the roller elements and are arranged to cooperate with the roller elements to allow for axial and angular displacement between the inner ring and the first outer ring. The bearing assembly further comprises a first thrust bearing arrangement comprising a second set of rolling elements arranged in a second row, which rolling elements are in contact with and arranged to cooperate with a second inner raceway and a second outer raceway for supporting axial loads and for restricting axial movement of the shaft in relation to the first outer ring.

The invention is based on the realization by the inventors that an improved and more compact bearing assembly for rotatably supporting and axially locating, at least in a first axial direction, a rotatable shaft is realized by forming a bearing unit comprising a toroidal roller bearing arrangement having a geometrical design which is inherently arranged to enable and allow for self-alignment and unconstrained axial displacement, in combination with a thrust bearing arrangement for supporting axial loads and restricting axial movements of the shaft.

This solution is advantageous in that it enables a compact design which allows for angular misalignment, has a more compact cross section and which may support increased or same radial and axial loads, while reducing the required installation space and reducing the weight of the bearing arrangement. Hence, the solution according to the present invention save space, weight and production costs while allowing the same or improved performance. Also, the rotational inertia of the bearing arrangement is decreased allowing for more efficient operation.

Furthermore, the design of the rollers and raceways of the toroidal roller bearing arrangement which enable relative self-alignment and unconstrained axial displacement between the rollers and raceways, also enable self-guiding operation of the rollers in relation to the raceway. Hence, during operation, when the shaft experience angular misalignment, while the thrust bearing arrangement restricts axial movements of the shaft, the rollers of the toroidal bearing adapt a position in relation to the raceways of the toroidal roller arrangement such that the internal loads are evenly distributed over the at least a portion of the roller axial length and raceways. In turn, lower internal loads reduces the friction of the bearing assembly which leads to reduced power loss of applications arranged with the bearing assembly, such as a wind turbine application. Also, the solution is advantageous in that internal loads are separated between the toroidal and thrust bearing arrangements which leads to that the internal contact loads between the members of the bearing assembly are reduced.

The bearing assembly further improves the limitation of axial displacement of the rotating shaft during operation which increases life time of the arrangement and life time and performance of devices operatively connected to the rotating shaft, such as a gear box, generator, turbine, etc.

Each row of rolling elements may, according to an exemplifying embodiment, form a row of aligned rolling elements which extend and roll circumferentially around the inner ring, or their respective inner rings, and around the shaft, during operation, in an annular configuration.

According to an exemplifying embodiment, the first set of rolling elements, being formed of toroidal roller elements, are slightly crowned symmetrical rollers having a convex shape in the axial direction, wherein the first inner and/or outer raceway of the toroidal roller bearing arrangement is/are concave and adapted to cooperate with the convex shape of the first set of the toroidal rolling elements, and is/are further situated symmetrically about the bearing centre in the axial direction.

According to an exemplifying embodiment, the second inner raceway of the first thrust bearing arrangement is arranged in the inner ring. Thereby, inner ring of the bearing assembly is shared by the first and second set of rolling element. In other words, the inner ring of the toroidal bearing arrangement and the inner ring of the thrust bearing arrangement are integrated with each other which allows for a more robust and durable bearing assembly having a compact design. Also, mounting and incorporation into existing space of compact application designs are facilitated. During operation, the shared inner ring, which also may form a shaft washer, improves the internal forces transfer/distribution and load bearing capacity of both radial and axial loads.

According to an exemplifying embodiment, the second outer raceway is arranged in a second outer ring, wherein the second outer ring is connected to the first outer ring via a support structure. Hence, support structure is arranged to support the first outer ring in relation to the second outer ring. The support structure may advantageously be configured to control the position of the second outer ring cooperating with the second set of rolling elements in relation to the first outer ring, such that bearing assembly allows for misalignment but restricts the axial displacement of the shaft in relation to the inner ring. Also, the support structure provides a suitable support for operatively coupling the first and second rings in relation to each other during operation, and/or in relation to a housing of the application.

According to an exemplifying embodiment, the bearing assembly further comprises a second thrust bearing arrangement comprising a third set of rolling elements arranged in a third row, which rolling elements are in contact with and arranged to cooperate with a third inner raceway and a third outer raceway for supporting axial loads. By providing a first and second thrust bearing arrangement, the bearing assembly may advantageously be used for supporting axial loads and for restricting axial movements of the shaft in both axial directions in relation to the axis of the shaft. For example, according to an embodiment, the first and second thrust bearing are arrangements on opposite axial ends of the toroidal roller bearing arrangement. Hence, three sets of rolling elements which are arranged in annular essentially coaxial rows, which are separated in the axial direction, are provided.

According to an exemplifying embodiment, the third inner raceway of the second thrust bearing arrangement is arranged in the inner ring. By providing also the third raceway on the same inner ring as the toroidal roller bearing arrangement, a more compact and versatile bearing assembly capable of supporting radial and axial loads, wherein the forces are transferred through and supported by one inner ring, is provided. Also, the integration of several raceways of separate bearing arrangements for supporting loads in different directions is advantageous in that the loads are distributed in one ring having larger uniform and continuous body compared to providing the raceways on separate inner rings.

According to an exemplifying embodiment, the third raceway is arranged in a third outer ring, wherein the third outer ring is connected to the first outer ring via the support structure, wherein the third outer ring is connected to the first outer ring via the support structure. Hence, a bearing assembly comprising three separated outer rings, one for each one of the toroidal roller bearing arrangement and the first and second thrust bearing arrangement, is provided, wherein the outer rings are operatively supported, connected and/or at least partially restricted from relative movement in the axial direction in relation to each other by a common support structure.

According to an exemplifying embodiment, the second outer ring is movable in relation to the first outer ring in a radial direction in relation to the radial direction of the first outer ring, or in relation to the shaft. This is advantageous in that the ability of the bearing assembly to allow for misalignment of the shaft during operation is improved. For example, the design of the support structure enables the second outer ring to displace or translate in a radial direction in relation to a center axis of first outer ring during misalignment of the shaft, while restricting the axial movements of the shaft in the first axial direction.

According to an exemplifying embodiment, the second and third outer rings are movable in relation to the first outer ring in the radial direction of the first outer ring, or in relation to the radial direction of the shaft. This is advantageous in that the ability of the bearing assembly to allow for misalignment of the shaft during operation is improved. For example, the design of the support structure enables the second and third outer ring to displace or translate in a radial direction in relation to a center axis of the first outer ring during misalignment of the shaft, while restricting the axial movements of the shaft in the first axial direction, and in the opposite axial direction.

The support structure may also, according to various exemplifying embodiments, be arranged to provided relative displacement between the first and second outer rings or between the first, second and third outer rings, in other directions, such as in the axial or intermediate tilted directions. For example, the support structure may comprises an outer ring slide surfaces, wherein the second and/or third outer rings are arranged to abut the slide surface in the axial direction and slide against, and in relation to, the slide surface in the radial direction. The slide surface may also be tilted in relation to the radial direction of the first outer ring, for example in a direction anywhere between 0,01 and 5 degrees, or between 0,05 and 3 degrees. Hence, suitable displacement movement between any one of the second and third outer rings in relation to the first outer ring may be provided, wherein the angle is adapted to the dimensions of the toroidal roller bearing and the predicted, or actual, misalignment permitted by the bearing assembly.

According to an exemplifying embodiment, a contact angle of at least one of the thrust, or axial, bearing arrangements of the bearing assembly exceeds 20 degrees, or 25 degrees, or 35 degrees, or 45 degrees. The contact angle a of the thrust bearing may for example be defined as the angle between a line joining the points of contact of the rolling elements and associated raceways in the radial plane, along which the load is transmitted from one raceway to another, and a line perpendicular to the bearing axis. According to an exemplifying embodiment, at least 25%, or 50%, 75% or 90% of the roller-contacting surfaces between the rolling elements of at least one of the thrust bearing arrangements and the corresponding inner and/or outer raceway which is operative during operation, has a contact angle that exceed the limit according to any one of the previous embodiments.

According to an exemplifying embodiment, at least one or each thrust bearing arrangement is formed of a spherical roller thrust bearing, a tapered roller bearing, a cylindrical roller thrust bearing, a thrust ball bearing, an angular contact ball bearing, or a combination of the two or more of these bearing types. For example, the first and second thrust bearing arrangement may be formed of different bearing types with different rolling element and raceways designs, such as according to the characteristics of any one of exemplified bearing types described above.

According to an exemplifying embodiment, the second outer raceway of the first thrust bearing arrangement is arranged in the first outer ring. Thereby a more compact and efficient outer integrated outer ring configuration comprising both the first and second outer raceway is provided.

According to an exemplifying embodiment, the bearing assembly further comprises a second thrust bearing arrangement comprising a third set of rolling elements arranged in a third row, which rolling elements are in contact with and arranged to cooperate with a third inner raceway and a third outer raceway for supporting axial loads, wherein the third outer raceway of the second thrust bearing arrangement is arranged in the first outer ring. Hence, the first and second thrust bearing arrangements are configured in back-to-back arrangement which is more stiff which reduces the permitted misalignment.

According to a further aspect thereof, the present invention relates to the use of the bearing assembly according to any aspect or embodiment the present invention for supporting radial and axial forces of a shaft.

According to a further aspect thereof, the present invention relates to a wind turbine arrangement comprising a rotor shaft supporting wind turbine blades, which rotor shaft is supported by the bearing assembly according to any aspect or embodiment the present invention. For example, the bearing assembly forms the main bearing of a wind turbine application for supporting the wind turbine rotor shaft in relation to a nacelle housing, or corresponding structure.

According to a further aspect thereof, the present invention relates to a method for manufacturing a bearing assembly for supporting a shaft, which method comprises:
providing a first set of rolling elements arranged for operation in a toroidal bearing arrangement,
arranging the first set of rolling elements in a first row interposed between an inner ring comprising a first inner raceway and a first outer ring comprising a first outer raceway, wherein the first inner and outer raceways are configured to cooperate with the roller elements to allow for axial and angular displacement between the inner ring and the first outer ring,
   wherein the method further comprises:
providing a thrust bearing arrangement comprising a second set of rolling elements, and
arranging the second set of rolling elements in a second row, wherein the second set of rolling elements are arranged to cooperate with a second inner raceway and a second outer raceway for supporting axial loads and for restricting axial movement of the shaft in relation to the first outer ring.

The method is advantageous in that an improved bearing assembly is provided which is more compact and has enhanced performance in terms of friction and internal load/stress distribution which increase operational life time and/or allows for reduced size and material savings. The method is further advantageous in similar manner as described in relation to any other aspect or embodiment of the present invention, and the manufacturing may be realized in an improved manner. For example, mounting and integration of the bearing assembly in various applications may be achieved without damaging the rings and roller elements. Also, the assembly may be performed more time efficient using less steps and by utilizing improved and more time efficient tools and machinery.

Generally, other objectives, features, and advantages of the present invention will appear from the following detailed disclosure, from the attached dependent claims as well as from the drawings are equally possible within the scope of the invention.

### BRIEF DESCRIPTION OF DRAWINGS

Embodiments of the invention will now be described, by way of example, with reference to the accompanying drawings, wherein:

FIG. 1 is a schematic cross-sectional view of an exemplifying embodiment of the bearing assembly according to the present invention, which bearing assembly comprises a toroidal roller bearing arrangement and a first thrust bearing arrangement.

FIG. 2 is a schematic cross-sectional view of an exemplifying embodiment of the bearing assembly according to the present invention, which bearing assembly comprises a toroidal roller bearing arrangement and a first and second thrust bearing arrangement provided on separate axial sides of the toroidal roller bearing arrangement.

FIG. 3 is a schematic cross-sectional view of an exemplifying embodiment of the bearing assembly according to the present invention.

FIG. 4 is a schematic cross-sectional view of an exemplifying embodiment of the bearing assembly according to the present invention.

FIG. 5 is a schematic cross-sectional view of an exemplifying embodiment of the bearing assembly according to the present invention.

FIG. 6 is a schematic side view of a application comprising a bearing assembly according to an embodiment of the present invention.

FIG. 7 is a schematic flow chart of a method for manufacturing a bearing assembly for supporting a rotating shaft according to an embodiment of the present invention.

It is noted that the drawings are not true to scale, and, as is readily appreciated by a person skilled in the art, dimensions other than those illustrated in the drawings are equally possible within the scope of the invention. It is also to be noted that some details in the drawings may be exaggerated in comparison with other details. Furthermore, some of the drawings have been simplified by removing some details relating to the rotational symmetry of the bearing assembly.

### DETAILED DESCRIPTION OF EMBODIMENTS OF THE INVENTION

In the drawings, similar, or equal elements are referred to by equal reference numerals. If not stated or illustrated otherwise, the described embodiments are arranged in a similar or corresponding manner.

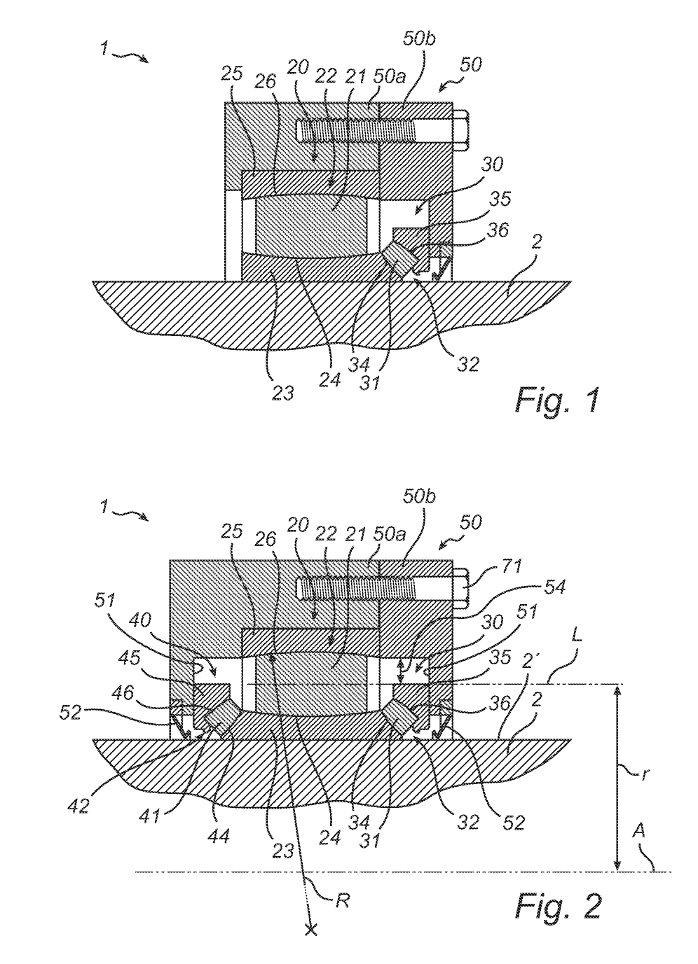

In FIGS. 1-5, schematic cross-sectional views of an exemplifying embodiments of the bearing assembly 1 for supporting a shaft 2 are shown. The assembly 1 comprises a toroidal roller bearing arrangement 20 comprising a first set of rolling elements being formed of toroidal roller elements 21, which toroidal roller elements 21 are arranged in a first annular circumferential row 22 around an axis of the shaft A and interposed between an inner ring 23 comprising a first inner raceway 24 and a first outer ring 25 comprising a first outer raceway 26. The first inner and outer raceways 24 and 26 are in contact with the roller elements 21 and are arranged to cooperate with the roller elements, wherein the roller elements roll in relation to and against the raceway, to allow for axial and angular displacement between the inner ring 23 and the first outer ring 25. The bearing assembly 1 further comprises a first thrust bearing arrangement 30 comprising a second set of rolling elements 31 arranged in a annular circumferential second row 32 in relation to the axis of the shaft A, which rolling elements 31 are in contact with and arranged to cooperate with and roll with rolling contact in relation to a second inner raceway 34 and a second outer raceway 36 for supporting axial loads and for restricting axial movement of the shaft 2 in relation to the first outer ring 25. The toroidal roller elements are provided with a convex cross-section, wherein the cross-section is taken in a geometrical plane coinciding with the axis of the roller element, and convex contacting surface having a radial curvature, each represented by R in FIG. 2, wherein the radius of the curvature considerably exceeds the center radial dimension of the path of rolling elements, as represented by r in FIG. 2, or the radius of the bearing assembly or the shaft radius, in contrast to spherical rolling bearing designs. Furthermore, the raceways associated with the toroidal roller elements are provided with a corresponding concave cross-section and concave roller-contacting surface having essentially similar radius of curvature R, wherein the raceways are adapted to cooperate with the toroidal roller elements to enable relative misalignment and at least partial unconstrained axial displacement. According to exemplifying embodiments, the ratio between the radius of curvature R of the toroidal rollers/raceways and the radius of the bearing r may exceed at least 1,5:1, or 2:1, or 3:1 or 5:1, or 10:1.

As further illustrated, with reference to FIGS. 1-4, the second outer raceway 36 is arranged in a second outer ring 35, wherein the bearing assembly 1 further comprises a support structure 50 arranged to support the second outer ring 35 in relation to the first outer ring 25.

As illustrated in FIG. 1 and FIG. 2, the second inner raceway 34 of the first thrust bearing arrangement 30 is arranged in the inner ring 23. Hence, as illustrated, the inner ring comprises a first radially outer roller-contacting surface which forms the first inner raceway and a second radially outer rolling-element-contacting surface which forms the second inner raceway.

As shown, with reference to FIGS. 2-4, the bearing assembly 1 comprises a second thrust 40 bearing arrangement comprising a third set of rolling elements 41 arranged in a third row 42, which rolling elements are in contact with and arranged to cooperate with a third inner raceway 44 and a third outer raceway 46. In FIGS. 2 and 4, the third inner raceway 44 of the second thrust bearing arrangement is arranged in the inner ring 23. Hence, the inner ring comprises a further third radially outer roller-contacting surface which forms the third inner raceway. In other words, the inner ring 23 comprises three separated roller-contacting surfaces each having a normal direction directed away from the shaft 2 in the radial direction.

With reference to FIG. 2-4, the third outer raceway 46 is arranged in a third outer ring 45, and the support structure 50 is arranged to support the third outer ring 45 in relation to the first outer ring 25. The support structure 50 may comprise a first support portion 50a arranged to mainly accommodate the first outer ring 25 of the toroidal roller bearing arrangement 20, and a second support portion 50b which may be secured to the first support portion 50a by attachment means 71, e.g. a screw, such that the orientation of outer ring 35 and/or 45 are secured in relation to the first outer ring 25, at least in the axial direction. The support structure 50 is arranged to accommodate and control the position of the outer rings of the bearing assembly and integrate the toroidal roller bearing arrangement and first and second thrust bearing arrangement into an integrated bearing unit or bearing hub.

As further illustrated in e.g. FIG. 2, the support structure 50 comprises slide surfaces 51 arranged to cooperate with the second and third outer rings 35 and 45, wherein the second and third outer rings may slide in the radial direction in relation to the support surface in space 54 arranged radially outside the second and third outer rings 35 and 45, respectively. The support structure is further provided with sealing means 52 arranged to abut the outer surface 2′ of the shaft 2, for example in order to prevent dirt and contamination from reaching the inside of the bearing arrangement and/or to maintain lubrication and oil inside the bearing assembly.

With reference to FIG. 1, the bearing assembly 1 comprises only the toroidal roller arrangement and the first thrust bearing arrangement, such that it mainly may accommodate and support axial loads in one direction.

As shown in FIG. 2-5, the bearing assembly 1 comprises a first and second thrust bearing arrangement 30 and 40 which are symmetrically arranged on opposing axial sides of the toroidal roller bearing arrangement 20, which thrust bearing arrangements 30, 40 are configured to restrict axial movement of the shaft 2 while permitting misalignment movements of the shaft 2 in correspondence with the misalignment movements of the shaft 2 permitted by the toroidal roller bearing arrangement 20.

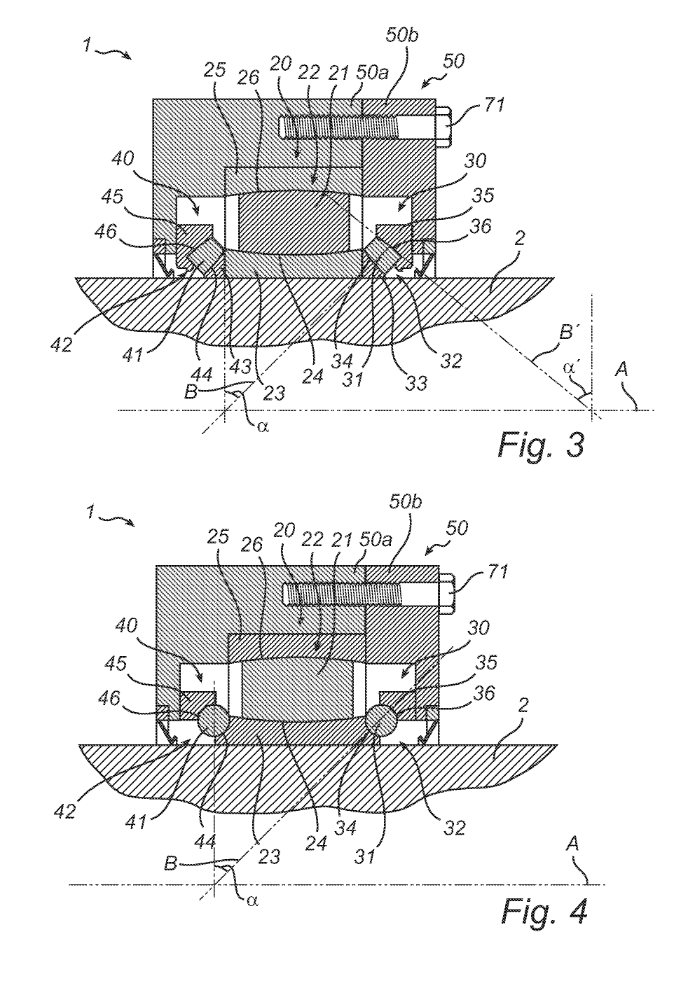

With reference to FIG. 3, the first, second and third inner raceways 24, 34 and 44 are provided on individual inner rings 23, 23b, and 23a, respectively, which inner rings are arrange adjacent each other in an axially abutting configuration, wherein the first inner ring 23 is in a axial center position.

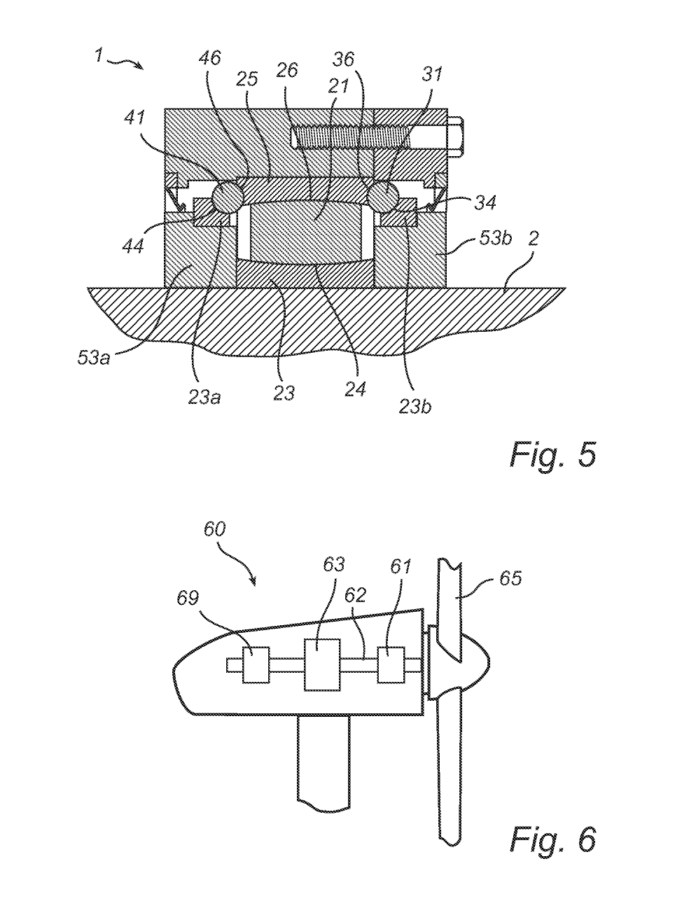

In FIG. 5, a schematic cross-sectional view of an exemplifying embodiment of the bearing assembly 1 according to the present invention is shown, wherein the second outer raceway 36 of the first thrust bearing arrangement is arranged in the first outer ring 25. As further illustrated in FIG. 5, the bearing assembly 1 comprises a second thrust bearing arrangement 40 comprising a third set of rolling elements 41 arranged in a third row 42, which rolling elements are in contact with and arranged to cooperate with a third inner raceway 44 and a third outer raceway 46 for supporting axial loads, and the third outer raceway 46 of the second thrust bearing arrangement is arranged in the first outer ring 25. Hence three separated roller-contacting surfaces which forms three axially separated raceways are integrated in the same outer ring 25, wherein the thrust bearing arrangements 30 and 40 are configured in a back-to-back configuration which increases the axial load bearing capacity.

As illustrated, with reference to FIGS. 1-3, the thrust bearing arrangements 30 and 40 are formed of spherical roller thrust bearings, wherein the load during operation in an application is transmitted from one raceway to the other at an angle to the bearing axis, which enable accommodation and support for axial loads, as well as radial loads. Furthermore, the rollers of the spherical roller thrust bearings are self-aligning, which improves and facilitates the compatibility between the toroidal roller bearing arrangement and the thrust bearing arrangement during operation involving misalignment. Also, the self-aligning capability of the spherical roller thrust bearing when employed as a thrust bearing arrangement in the bearing assembly, improves the bearing assembly and makes it less sensitive to shaft deflection and misalignment of the shaft relative to a housing. As shown in the depicted embodiment, the rollers are asymmetrical rollers which have a shape and form which is designed and adapted in relation to the contacting surface of the raceways for increased and efficient conformity.

As illustrated with reference to FIGS. 4 and 5, the thrust bearing arrangements 30 and 40 are formed of angular contact ball bearings. The corresponding raceways 34 and 36, 44 and 46 of the angular contact ball bearing are displaced with respect to each other in the direction of the bearing axis, such that they may accommodate and support combined loads i.e. simultaneously acting radial and axial loads, wherein the axial load carrying capacity of angular contact ball bearings increases with increasing contact angle. The contact angle of the angular contact ball bearing a may be defined as the angle between the line B joining the points of contact of the ball 31 and the raceways 34, 36 in the radial plane, as illustrated, along which the load is transmitted from one raceway to another, and a line perpendicular to the bearing/shaft axis A. According to an embodiment of the assembly, the thrust bearing arrangement is configured to uptake essentially only axial loads.

In FIG. 6, a schematic side view of a wind turbine 60 comprising a bearing assembly 61 according to any embodiment of the present invention is shown. A rotor shaft 62 is supported to a wind turbine nacelle housing by the bearing arrangement 61, wherein the rotor shaft 62 is further operatively connected to the wind turbine blades 65, and to a generator 69 via a gear box 63. According to further embodiments, the rotor shaft 62 may be supported by a plurality of bearing arrangements 61 according to any embodiment of the bearing assemble according to the present invention or by the bearing arrangement 61 in combination with one or a plurality of additional single bearing units, such as non-locating bearings. The additional non-locating bearing or bearings may e.g. be toroidal bearings.

According to exemplifying embodiments, the shaft is support by a 3-point or 2-point suspension/support configuration comprising, in addition to the bearing arrangement 61, additional non-locating and/or locating bearings. The additional bearings may e.g. be located integrated with and/or adjacent to the gear box.

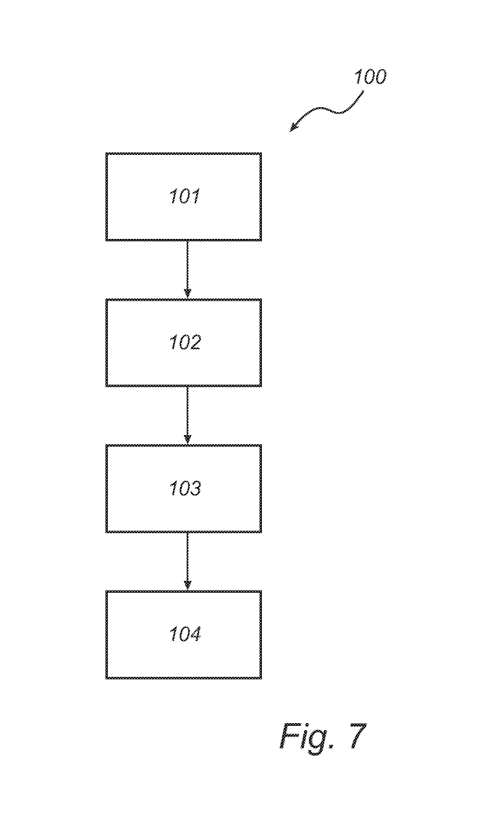

FIG. 7 is a schematic flow chart of a method 100 for manufacturing a bearing assembly for supporting a rotating shaft according to an embodiment of the present invention. The method comprises providing a first set of rolling elements, represented by 101, arranging the first set of rolling elements in a first row interposed between an inner ring comprising a first inner raceway and a first outer ring comprising a first outer raceway, represented by 102, providing a thrust bearing arrangement comprising a second set of rolling elements, represented by 103, and arranging the second set of rolling elements in a second row, wherein the second set of rolling elements are arranged to cooperate with a second inner raceway and a second outer raceway for supporting axial loads and for restricting axial movement of the shaft in relation to the first outer ring, represented by 104. The method may be performed automatically, in a process or manufacturing line comprising automate assembling means, and/or at least in a partially, or fully, manual mounting process performed by an assembler.

It should be noted that the invention has mainly been described above with reference to a few embodiments. However, as is readily appreciated by a person skilled in the art, other embodiments than the ones disclosed above are equally possible within the scope of the invention, as defined by the appended patent claims. For example, bearing assembly may also used with and/or integrated with other applications comprising rotating shafts, such as gear boxes, propeller/impeller/turbine shafts, hub units, such as wheel or rotational hub units, process applications, construction applications, construction vehicle solutions, drive train applications, actuator applications comprising rotatable members/shafts, etc., or combinations.

It is further noted that, in the claims, the word “comprising” does not exclude other elements or steps, and the indefinite article “a” or “an” does not exclude a plurality. A single apparatus or other unit may fulfill the functions of several items recited in the claims. The mere fact that certain features or method steps are recited in mutually different dependent claims does not indicate that a combination of these features or steps cannot be used to advantage

1. A bearing assembly for supporting a shaft, comprising:
a toroidal roller bearing arrangement having a first set of rolling elements formed of toroidal roller elements arranged in a first row and interposed between an inner ring providing a first inner raceway and a first outer ring including a first outer raceway,
wherein the first inner and outer raceways are in contact with the roller elements and are arranged to cooperate with the roller elements to allow for axial and angular displacement between the inner ring and the first outer ring,
wherein the bearing assembly further includes a first thrust bearing arrangement having a second set of rolling elements arranged in a second row in contact with and arranged to cooperate with a second inner raceway and a second outer raceway for supporting axial loads and for restricting axial movement of the shaft in relation to the first outer ring.

2. The bearing assembly according to claim 1,
wherein the second inner raceway of the first thrust bearing arrangement is arranged in the inner ring.

3. The bearing assembly according to claim 1,
wherein the second outer raceway is arranged in a second outer ring, and
wherein the second outer ring is connected to the first outer ring via a support structure.

4. The bearing assembly according to claim 3,
wherein the bearing assembly further comprises provides a second thrust bearing arrangement having a third set of rolling elements arranged in a third row which rolling elements are in contact with and arranged to cooperate with a third inner raceway and a third outer raceway for supporting axial loads and for restricting axial movement of the shaft in relation to the first outer ring.

5. The bearing assembly according to claim 4,
wherein the third inner raceway of the second thrust bearing arrangement is arranged in the inner ring.

6. The bearing assembly according to claim 5,
wherein the third outer raceway is arranged in a third outer ring, and
wherein the third outer ring is connected to the first outer ring via the support structure.

7. The bearing assembly according to claim 3, wherein the second outer ring is movable in relation to the first outer ring in a radial direction.

8. The bearing assembly according to claim 6, wherein the second and third outer rings are movable in relation to the first outer ring at least partially in a radial direction.

9. The bearing assembly (1) according to claim 1,
wherein a contact angle of at least one of the first and second thrust bearing arrangements exceeds 20 degrees.

10. The bearing assembly according to claim 1, wherein at least one or each thrust bearing arrangement is formed of a spherical roller thrust bearing, a tapered roller bearing, a cylindrical roller thrust bearing, a thrust ball bearing, or an angular contact ball bearing, or a combination of two or more of said bearings.

11. The bearing assembly according to claim 1,
wherein the second outer raceway of the first thrust bearing arrangement is arranged in the first outer ring.

12. The bearing assembly according to claim 11,
wherein the bearing assembly includes a second thrust bearing arrangement having a third set of rolling elements arranged in a third row in contact with and arranged to cooperate with a third inner raceway and a third outer raceway for supporting axial loads, and
wherein the third outer raceway of the second thrust bearing arrangement is arranged in the first outer ring.

13. (canceled)

14. A wind turbine arrangement comprising:
a rotor shaft supporting wind turbine blades supported by a bearing assembly, the bearing assembly having;
a toroidal roller bearing arrangement having a first set of rolling elements formed of toroidal roller elements arranged in a first row and interposed between an inner ring providing a first inner raceway and a first outer ring including a first outer raceway,
wherein the first inner and outer raceways are in contact with the roller elements and are arranged to cooperate with the roller elements to allow for axial and angular displacement between the inner ring and the first outer ring,
wherein the bearing assembly further includes a first thrust bearing arrangement having a second set of rolling elements arranged in a second row in contact with and arranged to cooperate with a second inner raceway and a second outer raceway for supporting axial loads and for restricting axial movement of the shaft in relation to the first outer ring.

15. A method for manufacturing a bearing assembly for supporting a shaft, comprising:
providing a first set of rolling elements arranged for operation in a toroidal bearing arrangement,
arranging the first set of rolling elements in a first row interposed between an inner ring comprising a first inner raceway and a first outer ring comprising a first outer raceway, wherein the first inner and outer raceways are configured to cooperate with the roller elements to allow for axial and angular displacement between the inner ring and the first outer ring, wherein the method further comprises:
providing a thrust bearing arrangement comprising a second set of rolling elements, and
arranging the second set of rolling elements in a second row, wherein the second set of rolling elements are arranged to cooperate with a second inner raceway and a second outer raceway for supporting axial loads and for restricting axial movement of the shaft in relation to the first outer ring.

16. The bearing assembly according to claim 1, wherein a contact angle of at least one of the first and second thrust bearing arrangements exceeds 25 degrees.

17. The bearing assembly (1) according to claim 1, wherein a contact angle of at least one of the first and second thrust bearing arrangements exceeds 35 degrees.

18. The bearing assembly (1) according to claim 1, wherein a contact angle of at least one of the first and second thrust bearing arrangements exceeds 45 degrees.
